(19) United States
(12) Patent Application Publication
(10) Pub. No.: US 2022/0376391 A1
(43) Pub. Date: Nov. 24, 2022

(54) Multiband Digital Data Network Infrastructure with Broadband Analog Front End

(71) Applicant: Battelle Memorial Institute, Columbus, OH (US)

(72) Inventor: Douglas A. Thornton, Upper Arlington, OH (US)

(21) Appl. No.: 17/751,823

(22) Filed: May 24, 2022

Related U.S. Application Data
(60) Provisional application No. 63/192,427, filed on May 24, 2021.

(51) Int. Cl. H01Q 3/34; H01Q 5/314

(52) U.S. Cl. CPC H01Q 3/34; H01Q 5/314; H04W 84/042

(57) ABSTRACT

A multiband digital data network infrastructure comprises a network of access points (APs). Each AP includes a differential segmented aperture (DSA) comprising a two-dimensional array of electrically conductive tapered projections disposed on a support board, modular analog front ends (MAFE's) configuring the DSA for different respective wireless services, an in phase/quadrature (IQ) board, and one or more network cards. The network of APs support two or more different wireless communication protocols operating in different RF bands. In some embodiments, each AP of the network supports both a cellular service and a WiFi service using the same DSA. In some embodiments, the network of APs form a network of cell towers of a cellular service. In some embodiments, the network of APs form a network of APs of an indoor wireless network.

This application claims the benefit of U.S. Provisional Application No. 63/192,427 filed May 24, 2021 and titled “Multiband Digital Data Network Infrastructure with Broadband Analog Front End”, which is incorporated herein by reference in its entirety.

### BACKGROUND

The following relates to the wireless communication arts, wideband communication arts, telecommunication arts, WiFi arts, cellular communication arts, and related arts.

Some illustrative embodiments disclosed herein employ differential segmented aperture (DSA) components. Some DSA embodiments are disclosed, for example, in U.S. Pub. No. 2020/0343646 A1 titled “Conformal/Omnidirectional Differential Segmented Aperture” and U.S. Pub. No. 2020/0343929 A1 titled “Systems and Methods for Signal Communication With Scalable, Modular Network Nodes”, both of which are incorporated herein by reference in their entireties.

### BRIEF SUMMARY

In accordance with some illustrative embodiments disclosed herein, a wireless network comprises a network of access points (APs). Each AP includes a broadband electronically steerable aperture, and electronics connected with the broadband electronically steerable aperture to receive and transmit wireless messages via the broadband electronically steerable aperture over a plurality of different frequency bands.

In accordance with some illustrative embodiments disclosed herein, a radio includes: a differential segmented aperture (DSA) comprising a two-dimensional array of electrically conductive tapered projections disposed on a support board; modular analog front ends (MAFE's) configuring the DSA for different respective wireless services; an in-phase/quadrature (IQ) board; and one or more network cards. The IQ board is configured to at least one of: (i) convert analog data received from the MAFE's to digital data delivered to the one or more network cards in a receive mode of the radio, and/or convert digital data received from the one or more network card to analog data delivered to the MAFE's in a transmit mode of the radio.

In accordance with some illustrative embodiments disclosed herein, a multiband digital data network infrastructure comprises a network of access points (APs). Each AP includes a differential segmented aperture (DSA) comprising a two-dimensional array of electrically conductive tapered projections disposed on a support board, modular analog front ends (MAFE's) configuring the DSA for different respective wireless services, an in phase/quadrature (IQ) board, and one or more network cards. The network of APs support two or more different wireless communication protocols operating in different RF bands. In some embodiments, each AP of the network supports both a cellular service and a WiFi service using the same DSA. In some embodiments, the network of APs form a network of cell towers of a cellular service. In some embodiments, the network of APs form a network of APs of an indoor wireless network.

### BRIEF DESCRIPTION OF THE DRAWINGS

Any quantitative dimensions shown in the drawing are to be understood as non-limiting illustrative examples. Unless otherwise indicated, the drawings are not to scale; if any aspect of the drawings is indicated as being to scale, the illustrated scale is to be understood as non-limiting illustrative example.

FIG. 1 diagrammatically shows an exploded view of a wideband radio.

FIG. 2 diagrammatically shows a perspective view of the RF aperture of the wideband radio of FIG. 1.

FIG. 3 diagrammatically shows an assembled view of the wideband radio of FIG. 1.

FIG. 4 diagrammatically shows a multi-tenant 5G/WiFi 6 outdoor network configuration employing four instances of the wideband radio of FIGS. 1-3.

FIG. 5 diagrammatically shows a private 5G/WiFi 6 network configuration employing three instances of the wideband radio of FIGS. 1-3.

FIG. 6 diagrammatically shows a network configuration for a mobile field operation employing an instance of the wideband radio of FIGS. 1-3.

### DETAILED DESCRIPTION

Disclosed herein are embodiments comprising a combination of wideband arrayed apertures and multi-channel RF signal chains capable of digitally operating on hundreds of MHz of bandwidth. Embodiments disclosed herein enable a single device to provide multi-band, multi-operator, and multi-function radio units for telecommunications. Such a radio unit, suitably configured to be standards compliant, can plug into one or more radio-access networks to provide coverage for multiple telecom operators, or multiple-bands/networks (3G, 4G, 5G, etc.)/waveforms (3GPP, WiFi, FM, etc.). Through multi-element beam forming, each signal has its own beam pattern enabling dynamic, digital control of tilt, beam width, and sectorization.

Existing 5G site installation entails considerable expense in running fiber, power, executing regulatory permitting, and performing the installation itself. This process can take upwards of 18 months and involves considerable staff effort, while also being subject to risk. Modifying the installation later requires re-permitting, which can be a 3-6 month process.

Embodiments disclosed herein reduce the number of 5G sites, and visits to reconfigure those sites, by having a single Radio Unit (RU) capable of supporting multiple bands, and dynamically switching between bands. This radio unit does so while reducing the cost of the radio system. Through reducing the number of boxes, the cost of permitting, enclosures, and the poles, and installation is also reduced.

An additional problem with existing multi-tenant sites is that each network operator is tied to the same operating parameters, such as beam pattern and tilt.

In embodiments disclosed herein, beam forming techniques enable each signal to have its own beam pattern and tilt. This enables better performance, and faster adaptation to changing network needs.

The combination of these features can decrease capital and maintenance costs of networks, on the order of 50% or better, while also providing higher performance.

Some aspects of certain embodiments disclosed herein include: providing single device, multiband, multi-waveform radio units; providing for digital steering and beamforming controlled independently for multi-networks from a single device; providing a single device that operates in multiple licensed or unlicensed bands for private/community networks including 4G, 5G, WiFi6, etc; providing a modular analog front end that enables a single aperture and single digitizer/radio board to be adapted to suit different signals and frequencies in a way that is executable in the field, and without change to the outward appearance of the device; providing a single device that serves as a multi-tenant radio unit in which the same aperture and electronics support multiple networks operators, and or multiple network types (5G, LTE, WiFi, etc.); providing a single device that can be digitally reprogrammed to switch frequencies and waveforms without changing or moving the antenna; and providing a radio that can support a different electronic tilt for different frequencies of simultaneous operation, and dynamically controls that tilt. A given embodiment may include one, more, or all of the above aspects and/or advantages.

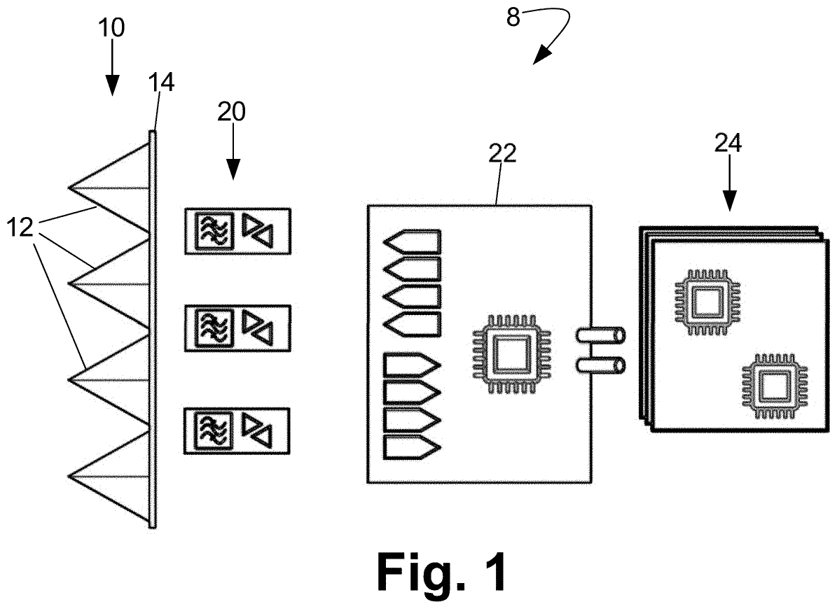

With reference to FIG. 1, an exploded view of a wideband radio 8 is shown. Embodiments of the wideband radio 8 disclosed herein comprise a wideband aperture 10 that is steerable at a contiguous frequency range, at least 1 GHz wide, and in some embodiments multiple gigahertz wide. In some illustrative embodiments, the wideband radio frequency (RF) aperture 10 can be a Differential Segmented Aperture (DSA) 10 that supports simultaneous electronic steering, polarization isolation, and wideband of many gigahertz. Some illustrative DSA embodiments are disclosed, for example, in U.S. Pub. No. 2020/0343646 A1 titled “Conformal/Omnidirectional Differential Segmented Aperture” and U.S. Pub. No. 2020/0343929 A1 titled “Systems and Methods for Signal Communication With Scalable, Modular Network Nodes”, both of which are incorporated herein by reference in their entireties.

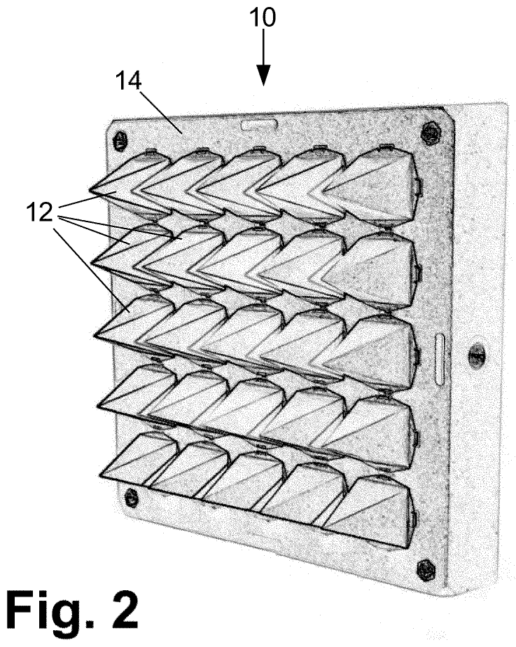

With continuing reference to FIG. 1 and with further reference to FIG. 2 which shows a perspective view of the RF aperture 10 of the wideband radio of FIG. 1, some suitable embodiments of the RF aperture 10 are further described. For example, as disclosed in U.S. Pub. No. 2020/0343929 A1, the DSA 10 may comprise a two-dimensional (2D) array of electrically conductive tapered projections 12 having bases disposed on the front side of a printed circuit board (PCB) or other support board 14 and extending away from the front side of the support board 14. FIG. 1 shows a side view of the DSA 10 showing a single row of the 2D array of the electrically conductive tapered projections 12, while FIG. 2 shows a perspective view depicting the 2D array of the electrically conductive tapered projections 12. The electrically conductive tapered projections 12 can have any type of cross-section (e.g. square as shown, or circular, hexagonal, octagonal, or so forth). The apexes of the projections 12 can be flat, or can come to a sharp point (as shown in FIGS. 1 and 2), or can be rounded or have some other apex geometry. The rate of tapering as a function of height (i.e. distance “above” the base of the projection, with the apex being at the maximum “height”) can be constant, as in the example of the inset, or the rate of tapering can be variable with height, e.g. the rate of tapering can increase with increasing height so as to form a projection with a rounded peak, or can be decreasing with increasing height so as to form a projection with a more pointed tip. Similarly, the 2D array of the electrically conductive tapered projections 12 can be a rectilinear array with regular rows and orthogonal regular columns, or the array may have other symmetry, e.g. a hexagonal symmetry, octagonal symmetry, or so forth. In one illustrative example, the base of each projection 12 is a square base and the electrically conductive tapered projection 12 has four flat slanted sidewalls; however, other sidewall shapes are contemplated, e.g. if the base and apex are circular (or the base is circular and the apex comes to a point) then the sidewall may suitably be a slanted or tapering cylinder; for a hexagonal base and a hexagonal or pointed apex there can suitably be six slanted sidewalls, and so forth. The DSA 10 has differential RF receive (or RF transmit) elements corresponding to adjacent pairs of the electrically conductive tapered projections 12. Generally, for a rectilinear array of the electrically conductive tapered projection 12 having a row (or column) of N electrically conductive tapered projections, there will be a corresponding N-1 pixels along the row (or column).

With continuing reference to FIG. 1, attached to the RF aperture 10 is more than one modular analog front ends (MAFE) 20. These MAFEs attach to sub-elements of the RF aperture 10, and the number of MAFEs 20 can be chosen based on the desired antenna count for multiple-input and multiple-output (MIMO) operation. Each MAFE 20 has amplification and filtering, and may or may not include frequency conversion. The MAFE 20 itself may support multiple bands of operation. These bands of operation may or may not be contiguous. For example, a MAFE may support a 20 MHz channel in L-Band, 40 MHz in S-Band, and 100 MHz in C-Band, simultaneously with each band having its own filters, amplifiers, and diplexer (for frequency division duplexing) or transmit receive switch (for time division duplexing). The MAFEs 20 across the RF aperture 10 do not need to be the same, however in some embodiments there are at least two of the same MAFEs 20 within the aperture. Through dissimilar MAFE, the aperture is sub-divided to support a greater number of simultaneous signals. The MAFEs 20 are preferably disposed close to the RF aperture 10 to reduce signal loss, noise, and cost. The MAFEs 20 are optionally designed to be field replaceable so that the personality of the radio 8 can be changed, in-situ, without any modification of the external appearance. This feature advantageously reduces costs of re-permitting a device, as its function can be changed without changing its external appearance.

In the illustrative embodiment of FIG. 1, the MAFEs 20 in turn connect to a Digital in-phase/quadrature (IQ) board or card 22 which converts the analog data into digital data (receive), or digital data into analog data (transmit). The digital IQ board 22 may also perform beam steering and beam forming, and channelization. The output and input of the digital IQ board 22 is digital I/Q (in-phase and quadrature) data. These data may follow a standardized format such as Enhance Common Public Radio Interface (eCPRI) or Open Radio Access Network (O-RAN). The digital IQ board 22 is connected with one or more network cards 24. These network card(s) 24 may be chosen to provide coverage for one, two, or more telecom operators, and/or for multiple-bands/networks (3G, 4G, 5G, etc.)/waveforms (3GPP, WiFi, FM, etc.).

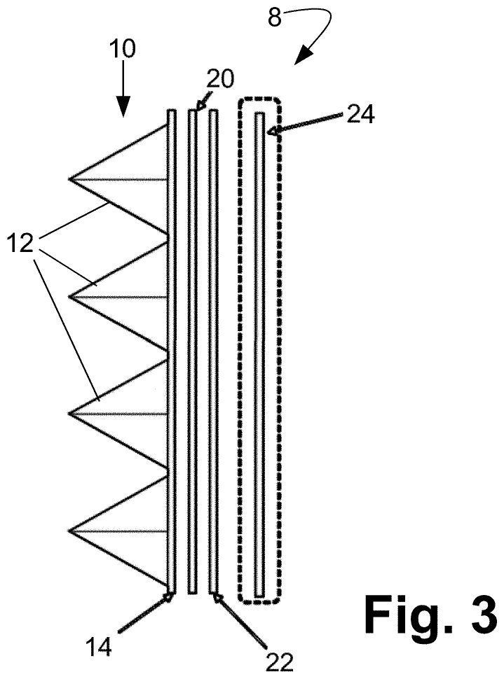

With reference to FIG. 3, an assembled view of the wideband radio 8 of FIG. 1 is shown. As diagrammatically depicted in FIG. 3, the digital IQ board or card 22 is also preferably located close the RF aperture 10 to reduce cost, weight, and increase performance. For example, FIG. 3 shows a compact arrangement of the RF aperture 10 including the electrically conductive tapered projections 12 disposed on the support board 14, with the MAFEs 20 and digital IQ board or card 22 and network card(s) 24 mounted in close proximity to the backside of the support board 14.

In the wideband radio 8 of FIGS. 1-3, the DSA 10 enables coverage of a wide band, e.g. the FR1 band (400 MHz to 7.125 GHz) as a nonlimiting illustrative example. The DSA 10 uses non-resonant elements that function with sub half-wavelength spacing, enabling more compact, multi-band, multi-antenna devices, which increases spectral efficiency. Through co-design with standards-compliant (e.g. O-RAN, eCPRI) digital backend, the radio 8 enables agile 5G radio unit (RU) capabilities from 8T8R (8 transmit/8 receive antenna elements) to 64T64R (64 transmit/64 receive antenna elements) and higher, with multiband capability. For instance, the DSA enabled radio 8 can serve Long-Term Evolution (LTE) on band 3 in a 20 MHz channel while simultaneously serving 5G on n78 with a 100 MHz channel, creating a single device 5G non-stand alone (NSA) solution that can be digitally updated to stand alone (SA).

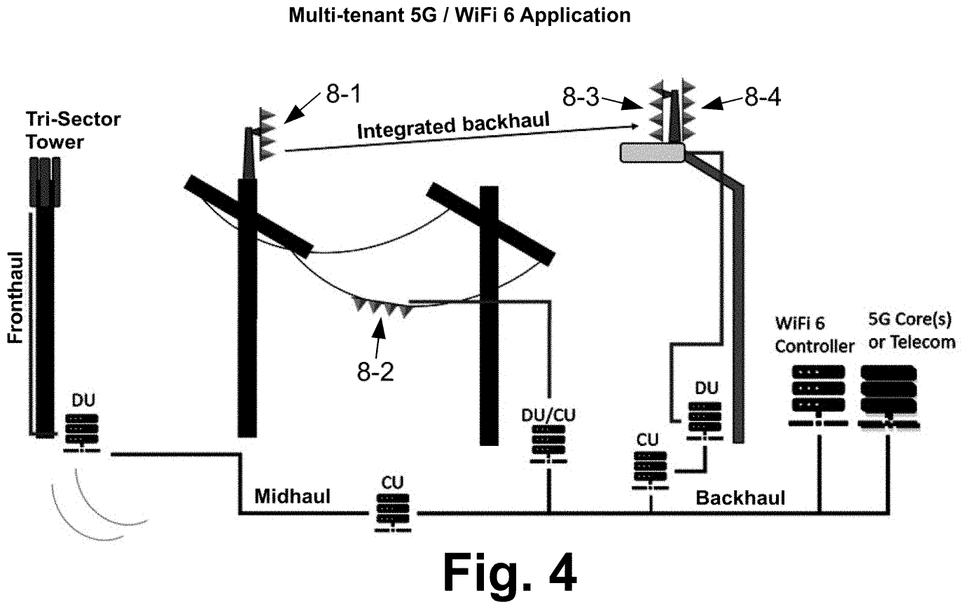

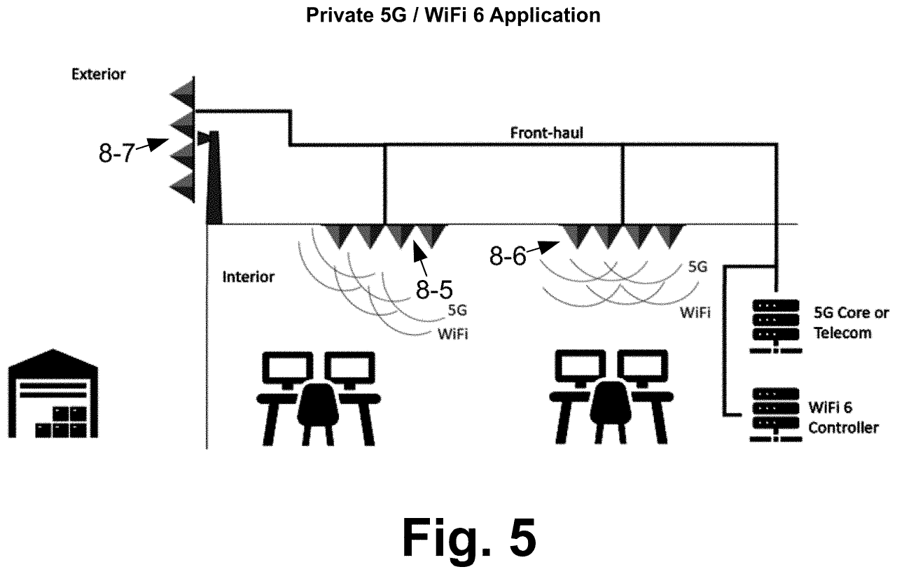

With reference now to FIGS. 4 and 5, various network configurations employing a wideband radio 8 such as that depicted in FIGS. 1-3 are contemplated. For example, as diagrammatically shown in FIG. 4 it is contemplated to provide only outdoor units, for example, implemented as cell towers or other types of outdoor wireless towers (e.g., optionally including both 5G and WiFi capability), only indoor units, for example providing a local 5G or hybrid 5G/WiFi network for an office building, or a combination of outdoor units and indoor units as shown in FIG. 5.

FIG. 4 depicts a multi-tenant 5G/WiFi 6 outdoor network configuration employing four illustrative instances of the wideband radio 8, including a pole-mounted wideband radio 8-1, a line-mounted wideband radio 8-2, and a light mount multi-panel configuration made up of two oppositely facing wideband radios 8-3 and 8-4. In FIG. 4, “CU” denotes a centralized unit of the network, while “DU” denotes a distributed unit of the network. The wideband radios 8-1, 8-2, 8-3, and 8-4 may for example serve as access points (APs) in the form of cell towers of a 5G or other cellular service.

FIG. 5 depicts a private 5G/WiFi 6 network configuration employing three illustrative instances of the wideband radio 8, including two ceiling-mounted wideband radios 8-5 and 8-6 for providing wireless communication indoors, and an exterior-mounted wideband radio 8-7 for connecting the residence with the exterior network (such as the outdoor network shown in FIG. 4). For example, the ceiling-mounted wideband radios 8-5 and 8-6 may be part of a wireless network supporting at least one office 5G service, and the ceiling-mounted wideband radios 8-5 and 8-6 form indoor access points (APs) of the wireless network.

In these examples, and as used herein, the “tenant” may be any wireless service, for example a 5G wireless cellular service provider, or a local office 5G service, or so forth. The use of the wideband radios 8 with wideband RF apertures 10 that are electronically steerable and operable over a frequency range of (in some illustrative examples) at least 1 GHz wide, or multiple gigahertz wide, enables this unifying wireless architecture to service a wide range of tenants while providing each tenant with flexibility as to factors such as the beam tilt, beam pattern (e.g. width), signal amplitude, and so forth. Wireless communication by multiple tenants operating in different bands with different beam parameters can be done simultaneously using a single aperture. Advantageously, the wideband radios 8 of the example networks of FIGS. 4 and 5 can support both a cellular service (e.g. 5G) and a WiFi service using the same broadband electronically steerable aperture (e.g., broadband radio 8).

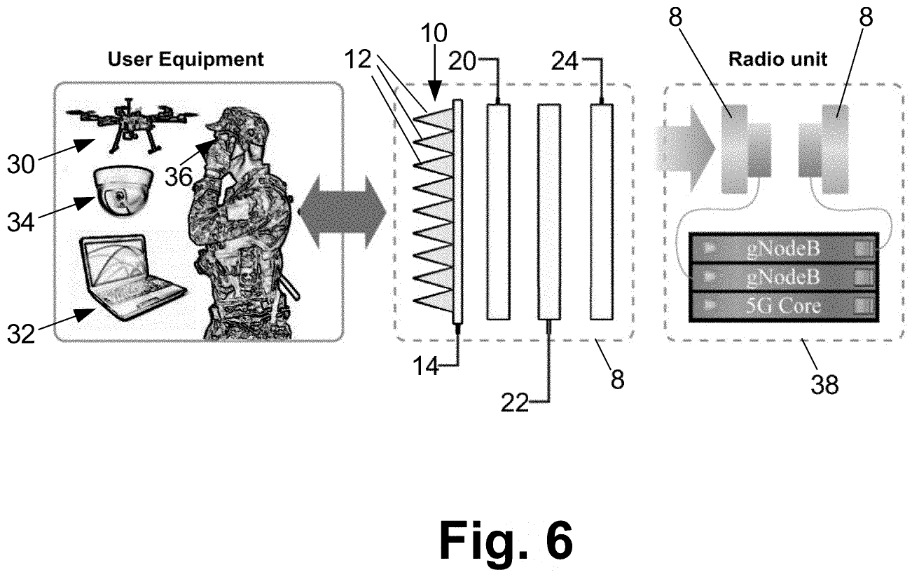

FIG. 6 diagrammatically shows a network configuration for a mobile field operation employing an illustrative instance of the wideband radio 8 of FIGS. 1-3, where the radio 8 again includes the RF aperture 10 with the electrically conductive tapered projections 12 having bases disposed on the front side of the support board 14, the analog front end 20, the digital IQ board 22 providing analog-to-digital/digital-to-analog conversion, and the one or more network cards 24. In a mobile field operation for military or covert purposes, the RF communication protocol may be a non-standard protocol, for example employing specialized encryption, spectral and/or spatial agility, and/or so forth. Hence, in this embodiment the one or more network cards 24 may optionally comprise one or more specially programmed field programmable gate array (FPGA) components. As an illustrative example, the wideband radio 8 may provide a 600 MHz to 8 GHz aperture in some nonlimiting examples. The illustrative field equipment for such an operation may, by way of example, include an unmanned aerial vehicle (UAV, i.e. a drone) 30, a notebook computer or other mobile computer 32, various sensors 34, a cellular telephone 36, and/or so forth. As diagrammatically shown on the right side of FIG. 6, a backend radio unit (RU) 38 can be constructed using two or more such wideband radios 8 to support various communication protocols such as gNodeB and 5G core. An embodiment such as that of FIG. 6 can for example provide a dedicated 5G network (or other-protocol network) with enhanced capability, such as frequency agility in 3rd Generation Partnership Project (3GPP) and National Telecommunications and Information Administration (NTIA) bands from 600 MHz to 7.125 GHz which enables operation and various locales and contested environments. Spatial Agility reduces signature and enables adaptation to changing spectrum environments. The system provides full auditability of code from 5G RU to core provides a trusted 5G solution, which optionally utilizes open standards such as O-RAN, evolved Common Public Radio Interface (eCPRI), or so forth to eliminate vendor lock-in. The system can be 5G Core replaceable. Multi-Gigabit connectivity can be provided to both commercial off-the-shelf (COTS) and military customized user equipment to reduce costs, keep speed with industry, and provide high bandwidth capabilities.

For domestic applications, the disclosed wideband radio 8 with advanced RF apertures and electronics can be used in many-band, steerable 5G Networks. The DSA 10 facilitates spatial and spectral agility of value for compact electronics, while microelectronics used in the various components 20, 22, 24 enable high instantaneous bandwidths exceeding 250 MHz, spread throughout the FR1 band (400 MHz to 7.125 GHz). A 90-degree sector size creates 2Gbit available throughput in each quadrant. Utilization of COTS 5G Core and Radio Access Network (RAN) software with open standards connectivity, provides rapid, cost effective, auditable 5G solution. Steerability of the DSA 10 and high channel count (32/64) establishes massive multi-user MIMO even in sub-6 GHz bands. 5G network security architecture provides vetted waveforms, and Subscriber Identification Module (SIM) based authentication to provide and maintain secure networks.

In an embodiment, a 5G system is designed using a DSA-based analog front end that provides: many band operation, (at least 3 bands, 2 concurrent); steering to support throughput, signature and interference benefits; gigabit throughput; utilization of COTS and/or design-specific user equipment; and operation in environments such as shipboard environments.

In general, the radio 8 through the use of suitable modular analog front ends (MAFE) 20, modular digital IQ board 22, and network card(s) 24 combined with the DSA 10 can be deployed in a range of applications such as electronic warfare (EW), signals intelligence (SIGINT), imagery intelligence (IMINT), command-and-control such as C4I, TTL, and so forth. The radio 8 can implement a wideband software-defined radio (SDR).

In the example networks of FIGS. 4-6 and variants described herein, the wideband radios 8 form a network of access points (APs) 8, where each AP 8 includes a broadband electronically steerable aperture 10 (e.g., the illustrative DSA 10) and electronics 20, 22, 24 connected with the broadband electronically steerable aperture 10 to receive and transmit wireless messages via the broadband electronically steerable aperture 10 over a plurality of different frequency bands, for example in a spectral range of 400 MHz to 30 GHz. In some embodiments, the plurality of different frequency bands may include 3rd Generation Partnership Project (3GPP) bands in a spectral range of 600 MHz to 7.125 GHz. In some embodiments, the plurality of different frequency bands may include National Telecommunications and Information Administration (NTIA) bands in a spectral range of 600 MHz to 7.125 GHz. In some embodiments, the plurality of different frequency bands may include 5G bands. In some embodiments, the wireless network supports at least one cellular service and the APs 8 include cell towers (e.g. cell towers 8-1, 8-2, 8-3, and 8-4 of the example of FIG. 4). In some embodiments, the wireless network supports at least one office 5G service and the APs 8 include indoor APs (e.g., the indoor APs 8-5 and 8-6 of the example of FIG. 5). In some embodiments, at least two APs 8 of the network of APs support both a cellular service (e.g. 5G) and a WiFi service using the same broadband electronically steerable aperture (e.g., broadband radio 8). In some embodiments, the electronics 20, 22, 24 include a plurality of modular analog front ends (MAFE's) 20 configuring the broadband electronically steerable aperture 10 for respective wireless services.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. A wireless network comprising:
a network of access points (APs) wherein each AP includes:
a broadband electronically steerable aperture; and
electronics connected with the broadband electronically steerable aperture to receive and transmit wireless messages via the broadband electronically steerable aperture over a plurality of different frequency bands.

2. The wireless network of claim 1 wherein the electronics are connected with the broadband electronically steerable aperture to receive and transmit wireless messages via the broadband electronically steerable aperture over said plurality of different frequency bands in a spectral range of 400 MHz to 30 GHz.

3. The wireless network of claim 1 wherein the broadband electronically steerable aperture comprises a Differential Segmented Aperture (DSA).

4. The wireless network of claim 1 wherein the plurality of different frequency bands includes 3rd Generation Partnership Project (3GPP) bands in a spectral range of 600 MHz to 7.125 GHz.

5. The wireless network of claim 1 wherein the plurality of different frequency bands includes National Telecommunications and Information Administration (NTIA) bands in a spectral range of 600 MHz to 7.125 GHz.

6. The wireless network of claim 1 wherein the plurality of different frequency bands includes 5G bands.

7. The wireless network of claim 1 wherein the wireless network supports at least one cellular service and the APs include cell towers.

8. The wireless network of claim 1 wherein the wireless network supports at least one office 5G service and the APs include indoor APs.

9. The wireless network of claim 1 wherein at least two APs of the network of APs supports both a cellular service and a WiFi service using the same broadband electronically steerable aperture.

10. The wireless network of claim 1 wherein the electronics include a plurality of modular analog front ends (MAFE's) configuring the broadband electronically steerable aperture for respective wireless services.

11. A radio comprising:
a differential segmented aperture (DSA) comprising a two-dimensional array of electrically conductive tapered projections disposed on a support board;
modular analog front ends (MAFE's) configuring the DSA for different respective wireless services;
an in-phase/quadrature (IQ) board; and
one or more network cards;
wherein the IQ board is configured to at least one of:
(i) convert analog data received from the MAFE's to digital data delivered to the one or more network cards in a receive mode of the radio, and/or
convert digital data received from the one or more network card to analog data delivered to the MAFE's in a transmit mode of the radio.

12. The radio of claim 11 wherein the digital IQ board performs at least one of beam steering and/or beam forming.

13. The radio of claim 11 wherein the one or more network cards include a plurality of network cards providing coverage for multiple RF bands.

14. The radio of claim 11 wherein the one or more network cards include at least one cellular network card and at least one WiFi network card.

15. The radio of claim 14 wherein the at least one cellular network card includes at least one of a 3G network card, a 4G network card, or a 5G network card.

16. The radio of claim 11 wherein the plurality of RF bands supported by the MAFE's include at least two of: a channel in L-Band, a channel in S-Band, and/or a channel in C-Band.

17. The radio of claim 11 wherein the MAFE's, the IQ board, and the one or more network cards are disposed on a backside of the support board of the DSA opposite from a frontside of the support board which supports the 2D array of electrically conductive tapered projections.

18. A multiband digital data network infrastructure comprising:
a network of access points (APs) wherein each AP includes a differential segmented aperture (DSA) comprising a two-dimensional array of electrically conductive tapered projections disposed on a support board, modular analog front ends (MAFE's) configuring the DSA for different respective wireless services, an in-phase/quadrature (IQ) board, and one or more network cards;
wherein the network of APs support two or more different wireless communication protocols operating in different RF bands.

19. The multiband digital data network infrastructure of claim 18 wherein each AP of the network supports both a cellular service and a WiFi service using the same DSA.

20. The multiband digital data network infrastructure of claim 18 wherein at least one of:
the network of APs form a network of cell towers of a cellular service; and/or the network of APs form a network of APs of an indoor wireless network.
